(19) United States
(12) Patent Application Publication
(10) Pub. No.: US 2006/0233591 A1
(43) Pub. Date: Oct. 19, 2006

(54) Writing Instrument With Magnetic Clip

(76) Inventor: Dan L Dietz, Houston, TX (US)

Correspondence Address: Jimmy Mark Gilbreth, P. O. Box 2428, Bellaire, TX, 77402-2428, US

(21) Appl. No.: 10/907,734

(22) Filed: Apr. 13, 2005

(51) Int. Cl. B43K 23/02; B43K 29/00

(52) U.S. Cl. 401/131; 401/195

(57) ABSTRACT

A writing instrument having an elongated body housing a writing mechanism and having an engagement surface that is magnetic or magnetizable. The instrument further includes a rigid clip supported by the elongated body, and a clip magnet supported by the clip and positioned on the clip sufficient to line up with and engage the engagement surface.

### BACKGROUND OF THE INVENTION

The present invention relates to writing instruments. In another aspect, the present invention relates to writing apparatus and to methods of attaching such instruments. In even another aspect, the present invention relates to writing instruments having a clip, and to methods of attaching such instruments. In still another aspect, the present invention relates to writing instruments having a magnetic clip, and to methods of attaching such instruments. In yet another aspect, the present invention relates to tools having a clip and to methods of attaching such tools.

For a number of years, writing instruments have been equipped with a clip for attachment of the writing instrument to most commonly a pocket or to anything else as desired. Past and present examples of such writing instruments can be found by the millions in offices, schools, and homes all across the world, with numerous models currently on sale in a wide variety of stores.

The patent literature is replete with examples of writing instruments with clips, the following of which are but a few.

U.S. Pat. No. 1,702,954, issued on Feb. 19, 1929, to Title, discloses a pencil attachment, which is described as including means designed primarily to constitute a clip faster for the pencil, as well as an envelope opener, bur it is to be understood that such means may be employed for any other purposes for which it is found applicable.

U.S. Pat. No. 1,839,066, issued Dec. 29, 1931 to Vivian discloses a device for securing fountain pens and the like in pockets of clothing and the like. Vivian notes the prior art spring band clips attach to the pen by a split spring band, which has a tendency to lose resiliency with the result that the clip will slip along the length of the pen. Vivian proposes an improved clip that will not so slip.

U.S. Pat. No. 1,970,611, issued Aug. 21, 1934 to Marshall, discloses spring type clip for use in connecting with fountain pens, such clip terminating in a ball or other bearing member.

U.S. Pat. No. 2,508,075, issued on May 16, 1950, to O. Morris, discloses a magnetized writing instrument, which are described as elongated tubular articles made of non-ferrous metal in which is incorporated a permanent magnet, fixed therein, to permit said articles to be placed on iron containing devices to which they are attracted. The instrument is also equipped with a standard spring pocket clip of usual construction.

U.S. Pat. No. 4,377,349, issued on Mar. 22, 1983, to Kunli, discloses a ball point pen which has a cartridge which can be projected by orienting the front end of a ball point pen main body downward and which can be retracted by orienting the front end of the main body upward. A weight with a notch or the like is mounted to the cartridge to shift the overall center of gravity of the cartridge and the weight from the axis of the main body. This allows complete engagement of the distal end portion of the cartridge with an engaging step formed inside the main body, so that accidental retraction of the cartridge back into the main body may be prevented during writing.

U.S. Pat. No. 4,516,869, issued on May 14, 1985, to Corpataux, discloses a clip for writing pen or similar object, which is a pocket fastening clip pivoted to a body by means of a connector rigid with and outside the body. A separate leaf spring is connected to the free end of the clip and is connected to the body by means of an opening formed in a device outside of and rigid with the body. The opening is between the pivot of the clip and the free end of the clip so that the clip covers and hides the spring by virtue of a groove in the clip in which the spring is dispersed.

U.S. Pat. No. 6,048,124, issued on Apr. 11, 2000, to Kawabe, discloses a writing implement and writing implement equipped with a writing implement clip. The writing implement has a movable attachment body at the end of a flexible connecting member that is fastened to the writing implement. The writing implement is further provided with a fixed attachment body. Either the movable attachment body or the fixed attachment body, or both, are made of magnets so that they are magnetically attached to each other, thus holding the writing implement in, for instance, a pocket. One of the problems with the '124 writing instrument is that because connecting member 30 is flexible, it does not provide a consistent insertion depth for any instrument inserted into a pocket. For example, a pen inserted in a deep pocket could fall to the bottom of the pocket to an extent that magnet 40 will not align with surface 50 without substantial repositioning of the pen.

While the following patents are not considered to be prior art because they do not related to writing instruments, but rather to carrying cases, they are disclosed because they discloses the use of a magnetic flap or magnetic clip.

U.S. Pat. No. 3,051,130, issued on Aug. 18, 1962, to R. S. Morris, discloses an invention which relates to improvements in cases and more particularly to cases of the pocket-size variety which are attachable to clothing or other objects for supporting and protecting means carried thereby which would otherwise be subject to loss or damage, thru the use of a magnetic flap.

U.S. Pat. No. 3,097,406, issued Jul. 16, 1963 to Yarborough, discloses are article holder or carrier especially of the variety conventionally inserted in a pocket of a garment, and to a clip or clasp that holds said article holder or carrier against inadvertent displacement from the pocket by use of a magnetic clip.

In spite of the above prior art developments, there is still a need in the art for improved writing instruments, instruments for writing instruments, and to instruments with clips.

These and other needs of the present invention will become apparent to those of ordinary skill in the art upon review of this specification, drawings and claims.

### SUMMARY OF THE INVENTION

It is an object of the present invention to provide for improved writing instruments, instruments for writing instruments, and to instruments with clips.

These and other embodiments of the present invention will become apparent to those of ordinary skill in the art upon review of this specification, drawings and claims.

According to one embodiment of the present invention, there is provided a writing apparatus. The writing instrument has a first engagement surface. A rigid clip is attached to the writing instrument and has a second engagement surface. The first engagement surface and the second engagement surface are magnetically coupled and aligned to provide an engagement zone between them.

According to another embodiment of the present invention, there is provided a method of modifying a writing instrument. The method includes affixing a clip comprising a first engagement surface to the instrument. The method further includes affixing a member to the instrument which comprises a second engagement surface. The first engagement surface and the second engagement surface are magnetically attracted to each other. The method even further includes aligning the first engagement surface and the second engagement surface to form an engagement zone there between.

According to even another embodiment of the present invention, there is provided a clip system for a writing instrument. The clip system includes a clip adapted for connection to a writing instrument and comprising a first engagement surface. The clip also includes an engagement member adapted for connection to a writing instrument and having a second engagement surface. In the system, the first engagement surface and the second engagement surface will magnetically couple when aligned.

According to still another embodiment of the present invention, there is provided a tool apparatus. The tool includes a first engagement surface. The tool also includes a rigid clip affixed to the tool and comprising a second engagement surface. The first engagement surface and the second engagement surface are magnetically coupled and aligned to provide a pinching zone between them.

### BRIEF DESCRIPTION OF THE DRAWINGS

FIG. 1 is an illustration of writing instrument 100 showing clip magnet 21 and mating instrument body magnet 19.

FIG. 2 is a top view of writing instrument 100 of FIG. 1.

FIG. 3 is a side view of writing instrument 100 of FIG. 1.

FIG. 4 is a cross-sectional view of writing 100 taken at A-A in FIG. 3.

FIG. 5 is an enlarged view of the top portion of writing instrument 100 showing details of connector system 120.

FIG. 6 is an illustration of two piece writing instrument 200 having top end 14A and bottom end 14B.

FIG. 7 is a top view of clip 11 of FIG. 6.

FIG. 8 is an illustration of two piece pen 300, with alternative caps 14D and 14E shown in FIGS. 9 and 10, respectively.

FIG. 11 is an illustration of connector system 420 mounted on pencil 114, showing clip 11, clip anchor 303, magnet 19 and end anchor 302.

### DETAILED DESCRIPTION OF THE INVENTION

The present invention generally provides a clip for securing instruments to another object, for example, an ink pen to a pocket. In generally the instrument is provided with a clip, with magnetic coupling between the clip and instrument securing the instrument to an object.

In one embodiment, the present invention more specifically provides a writing instrument having connector system which includes a clip, with the clip attached to the writing instrument and having a clip engagement surface, with is magnetically coupled with an engagement surface on the writing instrument. Positioned in a pocket, the writing instrument is anchored by pinching the pocket cloth in the engagement zone between the magnetically coupled engagement surfaces.

The present invention is most easily described by reference to the drawings in which like reference numbers refer to like members.

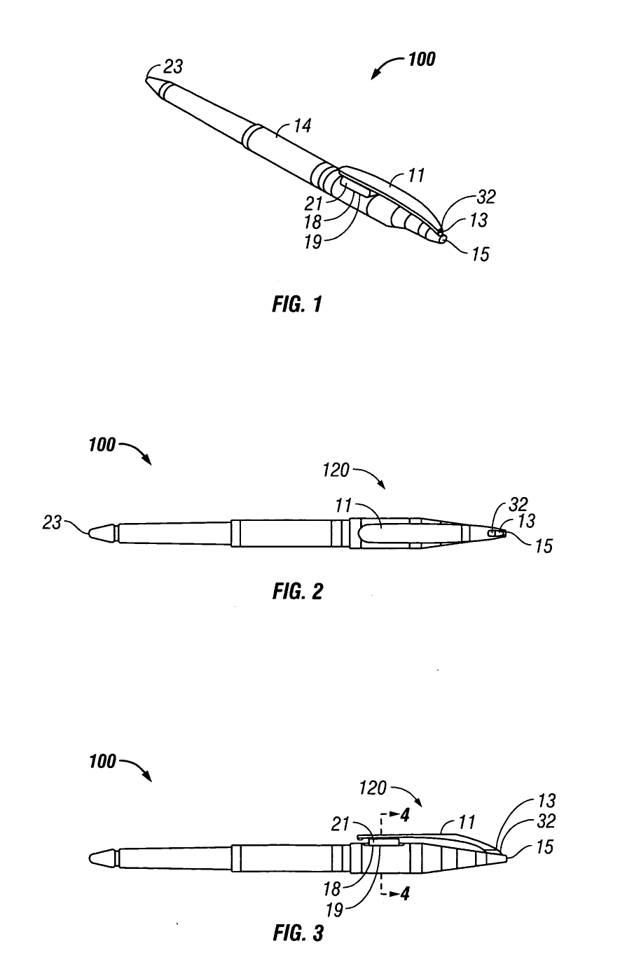

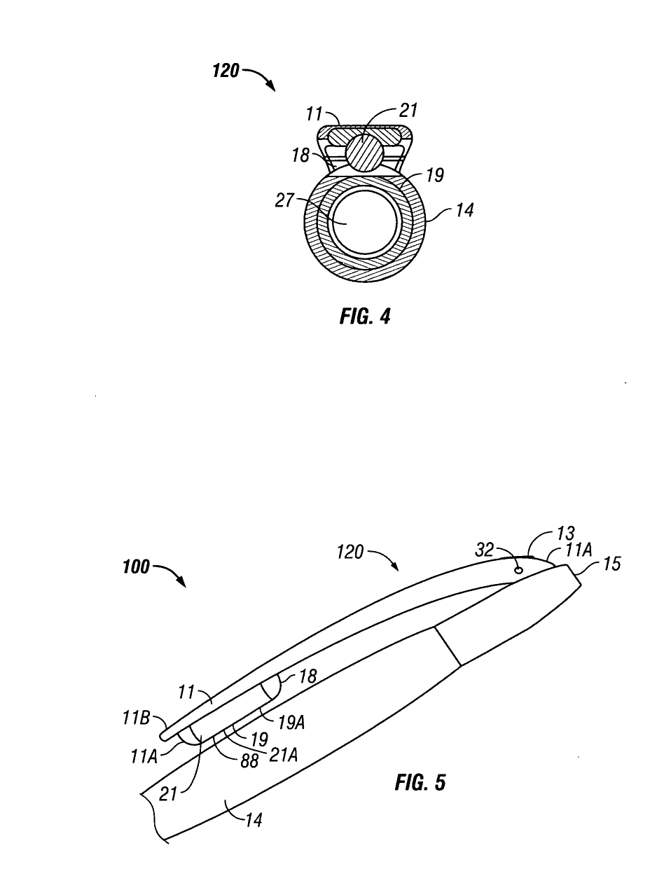

Referring now to the figures, FIG. 1 shows an illustration of writing instrument 100, with FIG. 2 and FIG. 3 showing a top view and side view of writing instrument 100 of FIG. 1, with FIG. 4 showing a cross-sectional view of writing instrument 100 at A-A of FIG. 3, and with FIG. 5 showing an enlarged view of clip system 120 of writing instrument of FIG. 1.

Writing instrument 100 includes instrument body barrel cap 14, defining a hollow portion 27, having a writing end or nib 23 and push button end 15, and connector system 120.

Connector system 120 includes clip 11 pivotally connected at pivot end 11A to instrument 100 at end 15 by hinge pin 32 inserted in hinge pin aperture 13 defined by clip 11 and end 15. Clip magnet 21 is connected to engagement end 11B by holder 33. Instrument body 14 defines magnet engagement slot 18 thru which a portion of instrument body ring magnet 19 is available for direct engagement with clip magnet 21 as clip magnet 21 is at least partially received into magnet engagement slot 18. Magnets 19 and 21 are magnetically coupled, that is, there is a magnetic attractive force acting between them. Of course, magnets 19 and 21 could also magnetically engage thru the wall of body 14 without the slot, but providing a slot 18 to allow for closer contact maximizes the attractive force between then.

Magnets 19 and 21 comprise engagement surfaces 19A and 21A, which are the surfaces which will engage the shirt pocket or other anchor objects. Engagement surfaces 19A and 21A are generally designed to maximize contact between the surfaces, and are thus usually relatively flat, although they can also comprise interlocking surface finishes.

It is not necessary that engagement zones 19A and 21A be perfectly aligned or of equal cross-sectional area, but at the very least, at least a portion of engagement zones 19A and 21A must be suitably aligned so as to provide a an engagement or pinching zone 88 between them where the shirt pocket material or other anchor item is pinched.

Magnet Clip 11 may be biased to favor the position which provides for direct engagement of engagement surfaces 19A and 21A, or at least biased to urge the engagement surfaces together. Such bias may be provided by utilization of a suitable spring mechanism. Additionally, clip 11 may have its own spring resilience and shaped to take advantage of that property. Clip 11 hinges around pin 32, with open movement of clip 11 restricted by the abutment of clip end 11A against push button end 15. It should be understood that clip 11 may also be rigidly attached rather than pivotally attached as is well known in the art.

Push button end 15 may be depressed to longitudinally move clip 11 and thereby disengage clip magnet 21 and ring magnet 19. Push button end 15 also functions to engage or disengage the internal writing mechanism of writing instrument 100. For reasons explained below, push button end 15 preferably operates a double action mechanism, that is, the first action serves only to disengage magnets 21 and 19 but will not reveal the writing point at end 23, and the second action serves to reveal the writing point at end 23. Push button end 15 may be configured so that a first full depression of button 15 engages the first action, and a full second depression of button 15 engages the second action. Alternatively and preferably, the initial depression travel of button 15 will engage the first action, and further depression travel of button 15 will at some point engage the second action.

Clip member 11 is a rigid member suitably rigid to translate the longitudinal movement of push button end 15 into longitudinal movement of magnet 21 away from ring magnet 19. While clip member 11 may have certain amount of flex, certainly clip member 11 must be rigid enough so as not to be considered to be a cord, chain, string, threat or the like.

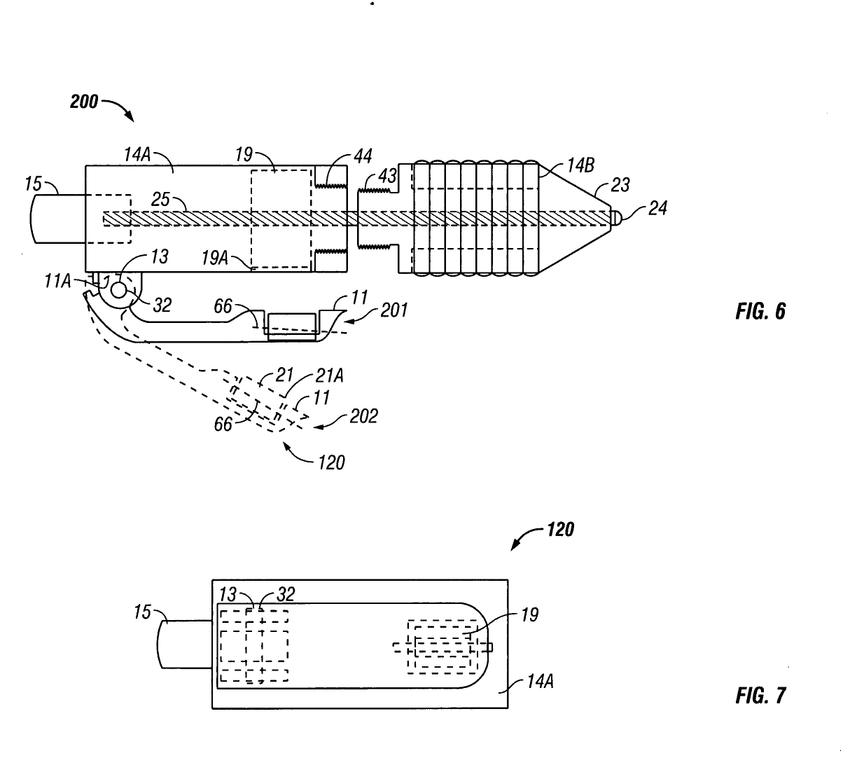

While clip 11 is shown attached to longitudinally movable push button end 15 and thus allow for longitudinal movement of clip 11, it should be understood that clip 11 may also be attached to writing instrument 100 in a manner that would not allow for longitudinal movement. For example to instrument body 14. Referring additionally to FIG. 6, there is shown two piece writing instrument 200 having top end 14A and bottom end 14B which engage across threads 44 and 43. FIG. 7 is a top view of clip 11 of FIG. 6. Contained therein is ink tube 25 having writing point 24.

Further illustrated in FIG. 6 is clip 11 shown moving from a closed position 201 to a more open position 202. Clip end 11A will restrict the open movement of clip 11. To allow magnet 21 engagement surface 21A to stay aligned with engagement surface 21, it is preferable to affix magnet 21 to allow it to float or move and self-orient during movement of clip 11. In the embodiment as shown, pin 66 is positioned in an oversized borehole to allow magnet 21 to move. Alternatively, pin 66 could be positioned to allow magnet 21 to teter-totter and stay aligned. As even another alternative, the ends of pin 66 could be positioned in slots to allow movement of magnet 21.

Clip 11 may also be slideably attached to writing instrument 100 in a manner as to move along longitudinally, for example, along a slot or groove, or by having clip 11 attached to writing instrument 100 by a ring or split ring that will allow for longitudinal movement of clip 11.

In addition, not all writing instruments will have a push button end, but instead may have a removable end cap. For such writing instruments, clip 11 may be attached to the removable cap or may be attached to the main body of the writing instrument.

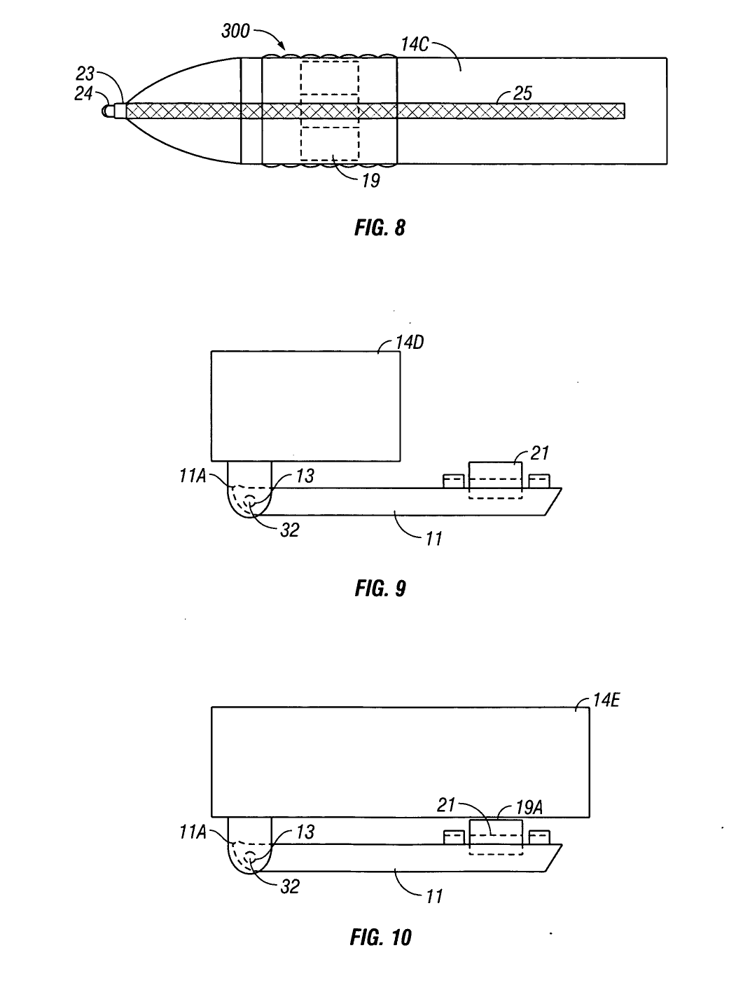

Referring now to FIGS. 8-10, there is shown an illustration of pen 300 with FIGS. 9 and 10 showing alternative hollow caps 14D and 14E, which fit over end 23 of writing instrument 300. With caps 14D and 14E in position on writing instrument 300, magnets 19 and 21 will align. While clip 11 is shown pivotally connected it should be understood that it may be rigidly connected. A ring magnet 19 is positioned inside pen body 14C. There may or may not be an engagement passage provided thru pen body 14C.

Both caps 14D and 14E comprise clip 11 on which is positioned magnet 21. The difference between the alternative embodiments, is that cap 14E extends further as to be interposed between magnets 19 and 21. Of course, an engagement passage may be provided in cap 14E.

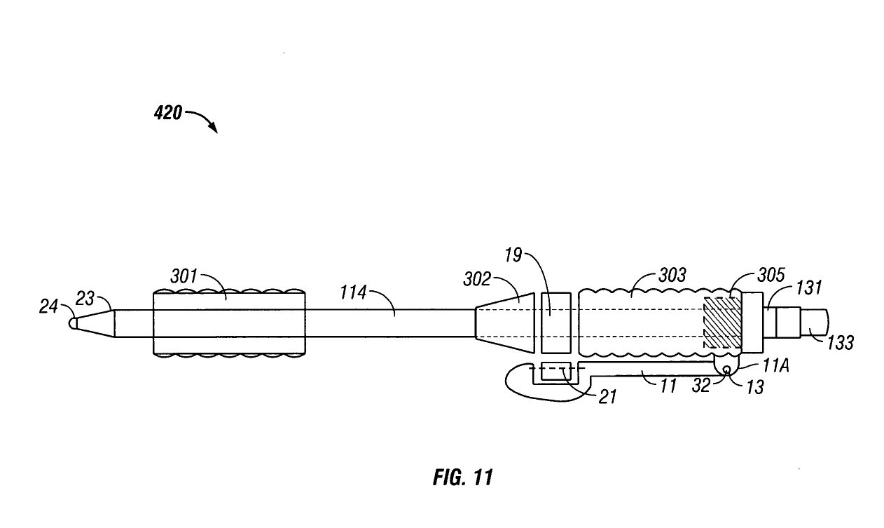

FIG. 11 is an illustration of connector system 420 mounted on pencil 114 having eraser holder 131, eraser 132, writing end 23, slidable grip 301, and writing tip 24. Connector system 420 includes clip 11, clip anchor 303, magnet 19 and end anchor 302. Connector member 305 secures clip 11 to clip anchor 303. Of course, one or all of clip 11, clip anchor 303 and connector 305 may be combined as desired. Member 305, magnet 19, and anchor 303 each have a passage there through for being slidably mounted on pencil 19. The diameter of the passages is selected to provide a firm friction fit that will resist causal movement of member 305, magnet 19 and anchor 303. Additionally the passages may be provided an interior coating or finish that will aid in a friction fit.

Connector system 420 may be utilized to modify a writing instrument to provide it with a clip.

Clip 11 can be utilized to securely affix writing instrument 100 to any number of items in which a portion of the item may be inserted into the pinching zone between the engagement surfaces of magnets 9 and 21, and securely pinched, including articles of clothing, especially pockets. For example, in positioning writing instrument 100 inside a pocket, clip 11 is positioned such that clip magnet 11 and ring magnet 19 are magnetically engaged and pinch the pocket material between them.

Writing instrument 100 may be released from a pocket by pulling instrument 100 out of the pocket with sufficient force to overcome the magnetic force between magnets 19 and 21 causing a pinching of the pocket material. Depending upon the strength of the pinch between magnets 19 and 21, pulling instrument 100 away from a pocket in the manner just described might wrinkle, crimp, stretch, distort or damage the pocket material. Alternatively, instrument 100 may be released by engaging push button end 15 to move clip 11 longitudinally down instrument 100 and slidably disengage magnets 19 and 21. With a single action mechanism, this would also mean that the internal writing mechanism is engaged into the bottom of the pocket, possibly causing the writing end to contact the pocket and stain the pocket with ink. Thus, it is preferable to utilize a double action mechanism, so that the first depression of button 15 will release instrument 100 and the second depression will then engage the writing mechanism.

Writing instrument 100 may house any suitable type of writing mechanism, non-limiting examples of which include ink cartridge, ball point pen, mechanical pencil mechanism, marker-type mechanism, craft pen, and the like.

While connector system 120 has been illustrated with a pair of magnetically coupled magnets 19 and 21, it should be understood that one or each magnet could be replaced with a grouping of magnets. It should also be understood that magnetically coupled magnet pair 19 and 21 could be replaced with a magnetically coupled pair comprising a magnet and a non-magnetic magnetically attractive member. The important factor is that a pair of engagement surfaces is provided that are magnetically attracted toward each other, and between the pair an anchoring object (such as shirt pocket material) can be pinched by the magnetic coupling biasing the surfaces together.

It should also be understood that while magnet 19 has generally be illustrated as being a ring magnet, magnet 19 may be any suitable shape.

Connector system 120 can also be enhanced by providing one or both of clip magnet 21 and ring magnet 19 with an enhanced engagement surface for more securely pinching material between them. Such an engagement surface may be obtained by providing a surface texture, finish or coating. For example, application of a coating that has a finish to suitable to resist movement of the material between the magnets. Such coatings can be selected for their frictional surface properties, can be provided with textured finishes that will enhance the frictional properties, or the surfaces can be provided with interlocking finishes to enhance the frictional properties such as interlocking ridges or teeth.

The connector system 120 of the present invention is believed to find utility with any sort of writing instrument. While a writing instrument generally thought of as providing ink, paint, graphite, chalk, crayon, glitter, or other marking media to a surface, it also includes instruments which form non-deposited marking/artistic indicia on a surface, such as harder items for making marking indicia on the surface of softer items such as a metal scribe, items which burn marking indicia on items (i.e., laser pens or brands), digital instruments which are used to “write” on a surface with the resultant writing appearing digitally on a display screen, and stylus which are used to “write” on a digitized surface with the resultant writing appearing digitally on a display screen.

Non-limiting examples of writing instruments include pencils, pens, ball point pens, fountain pens, glue pens, glitter pens, mechanical pencils, markers, stencils, chalk markers, make up pens, brushes, personal digital assistant writing stylus, wireless digital pen, and artistic instruments.

While the present invention has been illustrated mainly by reference to a writing instrument, is should be understood that the clip system of the present invention finds utility on a wide variety of tools which may be clipped for storage. As used herein, a tool refers to those items used to perform or facilitate manual or mechanical work, or for recording, or measuring.

Non-limiting examples of such tools include tools in general, instruments in general, pointers, telescoping pointers, mirrors, mountain climbing equipment, light/laser pointers, lights, laser measurement devices, elongated pen shaped recorders, thermometers, rulers, fuse testers, screw drivers, wrenches, pen knives, manual bottle openers, kitchen tools, levels, gadgets, dental instruments, surgical instruments, portable electronic equipment, cell phones, personal digital assistants, and the like. Such instruments and tools may be clipped to any desirable item, including a pocket, item of clothing, utility belt or harness, storage board, and the like.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains.

What is claimed is:

1. A writing apparatus comprising:
a writing instrument comprising a first engagement surface;
a rigid clip attached to the instrument and comprising a second engagement surface;
wherein the first engagement surface and the second engagement surface are magnetically coupled and aligned to provide an engagement zone between them.

2. The apparatus of claim 1, wherein the writing instrument comprises a push button, and wherein the clip is attached to the push button.

3. The apparatus of claim 1, wherein the clip is pivotally attached to the instrument.

4. The apparatus of claim 1, wherein the first engagement surface and the second engagement surface comprise magnets.

5. A method of modifying a writing instrument comprising:
affixing a clip comprising a first engagement surface to the instrument;
affixing a member to the instrument, wherein the member comprises a second engagement surface, and wherein the first engagement surface and the second engagement surface are magnetically attracted to each other;
aligning the first engagement surface and the second engagement surface to form an engagement zone there between.

6. A clip system for a writing instrument comprising:
a clip adapted for connection to a writing instrument and comprising a first engagement surface;
an engagement member adapted for connection to a writing instrument and having a second engagement surface;
wherein the first engagement surface and the second engagement surface will magnetically couple when aligned.

7. The clip system of claim 6, wherein the clip and the engagement member are adapted to be slidably connected to the writing instrument.

8. An apparatus comprising:
a tool comprising a first engagement surface;
a rigid clip affixed to the tool and comprising a second engagement surface;
wherein the first engagement surface and the second engagement surface are magnetically coupled and aligned to provide a pinching zone between them.
